(19) United States
(12) Patent Application Publication
(10) Pub. No.: US 2011/0235311 A1
(43) Pub. Date: Sep. 29, 2011

(54) BI-DIRECTIONAL LED SAFETY WEAR

(75) Inventor: Steven STONE, Staffordshire (GB)

(73) Assignee: LEDwear Limited, Staffordshire (GB)

(21) Appl. No.: 12/731,597

(22) Filed: Mar. 25, 2010

(51) Int. Cl. F21V 21/084; F21V 21/08

(52) U.S. Cl. 362/106; 362/103

(57) ABSTRACT

An apparatus and method of protecting a pedestrian or cyclist from accidental collision with a vehicle wherein a first strip is directly or indirectly mounted on the rear of a user; the first strip including a plurality of light emitting devices that emit red light upon activation by a power means; and a second strip that is directly or indirectly mounted on the front of a user; the second strip including a plurality of light emitting devices that emit white, near white light upon activation by a power means; the first and second strips preferably forming an integral part of a garment worn by the user.

### TECHNICAL FIELD

The invention relates to method of making a pedestrian or cyclist more visible in poor light conditions and in particular a method and apparatus for readily distinguishing the front of a user from the back of a user in such conditions. Thus, the invention provides additional protection of a user from accidental collision with a vehicle.

### DESCRIPTION OF THE RELATED ART

Cycling can be a hazardous activity, especially in poor weather conditions or at dusk or night-time. In such circumstances, cyclists are particularly vulnerable to being hit by motorized vehicles, often because they are poorly visible. This problem can be addressed by the use of reflective or luminous garments, armbands etc. However, such methods rely upon reflection of light from the headlights of oncoming vehicles etc., and often do not reveal the presence of the cyclist sufficiently early to avoid an accidental collision.

Walking on the roadside in poor weather, at dusk or night-time can present similar hazards as can roadside working in such circumstances.

### SUMMARY

An aim of the present invention is to provide an apparatus and method of protecting motorised cyclists (bikers), pedal cyclists (bicyclists) pedestrians and roadside workers from accidental collisions; especially with passing vehicles. Another aim of the invention is to provide means of making a user of the apparatus or method more visible in poor light conditions (for example mist, rain or fog), and in particular providing means to readily distinguish whether the user is facing front wards or backwards from an oncoming vehicle. A further aim is to provide apparatus that can be either attached to an existing garment or made as an integral part of a garment (including a hat). The method and apparatus of the invention allows an observer to be able to clearly determine the direction in which the wearer is traveling should the wearer not be stationary; for example if the wearer is traveling on a bicycle.

In one aspect the invention comprises a method of protecting a pedestrian or cyclist from accidental collision with a vehicle comprising the following steps: (a) mounting either directly or indirectly a first strip/array on the rear of a user; said strip comprising a plurality of light emitting devices that emit red light upon activation by a power means; and (b) mounting either directly or indirectly a second strip/array on the front of a user; said strip comprising a plurality of light emitting devices that emit white, or near white, light upon activation by said power means.

Preferably, said first and second strips of light emitting devices form an integral part of a garment worn by a user. The garment may comprise a jacket, trousers, hat or back-pack.

The power means may comprise a plurality of cells within a holder, operably connectable to said light emitting devices by a parallel wiring system, said holder being and attached to or stowed within said garment. The power means preferably includes conventional control electronics that intermittently or continuously activates the light emitting devices.

Preferably, the light emitting device comprises a light emitting diode (LED).

In another aspect the invention comprises apparatus for protecting a pedestrian or cyclist from accidental collision with a vehicle comprising a first strip/array adapted for detachable mounting either directly or indirectly on the rear of a user; said strip comprising a plurality of light emitting devices that emit red light upon activation by a power means; and a second strip adapted for detachable mounting either directly or indirectly on the front of a user; said strip/array comprising a plurality of light emitting devices that emit white or near white light upon activation by said power means.

Preferably, the first and second strips of light emitting devices form an integral part of a garment worn by a user. The garment may comprise a jacket, trousers, hat or back-pack.

The power means may comprise a plurality of cells within a holder, operably connectable to said light emitting devices by a parallel wiring system, said holder being and attached to or stowed within said garment. The power means preferably includes conventional control electronics that intermittently or continuously activates the light emitting devices.

Preferably, the light emitting device comprises a LED.

In another aspect the invention comprises a garment that in use presents an array of red LEDs on the backside of the garment and an array of white or near white LEDs on the front of the garment said arrays being powered by a battery pack that is attached to or stowed within said garment. Preferably, the garment is a jacket. The jacket has many uses including wearing when cycling or walking a dog; and use by bikers and rescue and emergency personnel or officials in traffic direction.

The garment may also be a hat, a vest, a coat, a pair of trousers, or a back-pack.

### BRIEF DESCRIPTION OF THE DRAWINGS

The invention will now be described by reference to the following diagrammatic drawings in which:

FIG. 1 is a front view of a safety jacket according to a preferred embodiment of the invention;

FIG. 2 is a rear view of the jacket shown in FIG. 1;

FIG. 3 shows a partial view of the opened jacket of FIG. 1 and in particular the power means and stowage arrangement;

FIG. 4 is a front view of a safety helmet according to another embodiment of the invention;

FIG. 5 is a rear view of the safety helmet shown in FIG. 4;

FIG. 6 is a front view of a pair of safety trousers according to a preferred embodiment of the invention;

FIG. 7 is a back view of the trousers shown in FIG. 6; and

FIG. 8 shows selected features of power means and connection means for the light emitting devices.

### DETAILED DESCRIPTION

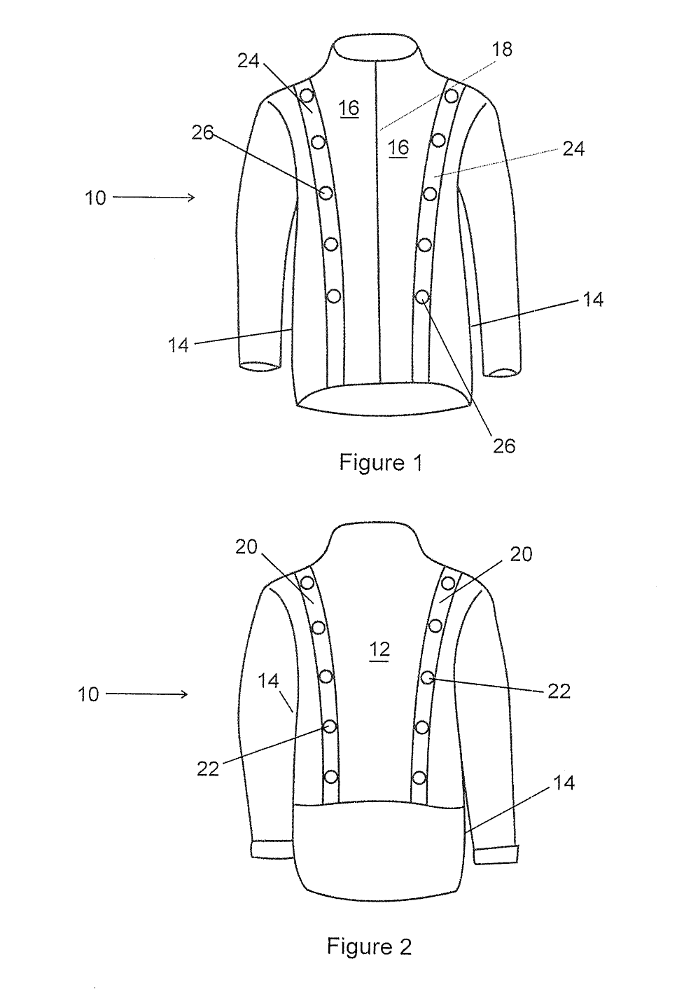

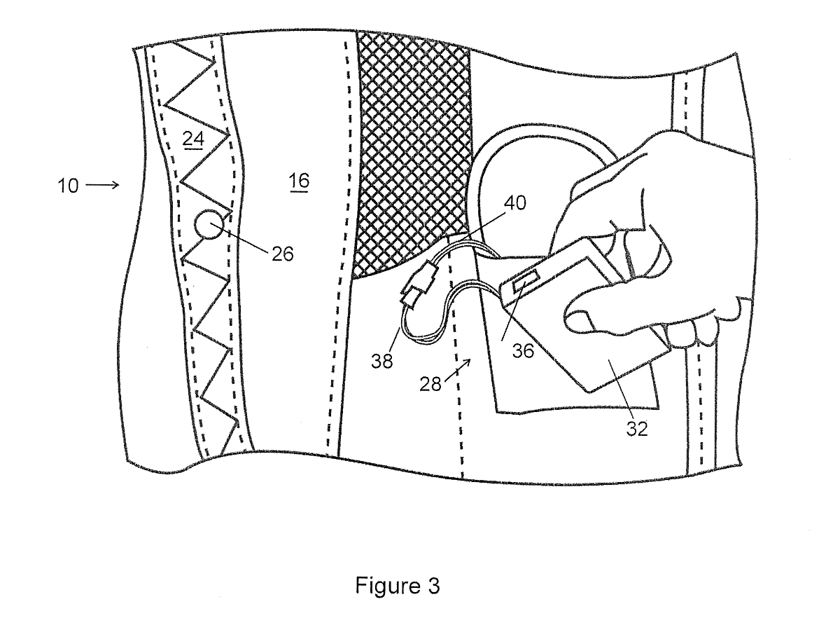

A preferred embodiment of the invention will now be described by reference to FIGS. 1-3 and 8; these figures show a bi-directional LED safety jacket.

The jacket (10) comprises a rear portion (12), side portions (14), and front portions (16); it also has conventional fastening means (18); for example, a zip or buttons. The jacket (10) has two vertical (in use) first strips (20) permanently attached to the rear portion (12); each strip comprising a plurality of LEDs (22) that can be activated to emit red light. Each front portion (16) of the jacket (10) has a vertical (in use) second strip (24) permanently attached thereto; each strip comprising a plurality of LEDs (26) that can be activated to emit white or near-white light. Each strip (20, 24) typically comprises five LEDs. The strips (20, 24) may further comprise vertical reflective yellow stripes of highly reflective material with the LEDs are mounted underneath, individual LEDs protruding through a clear plastic “bubble”. The sleeves of the jacket are optionally removable; thereby allowing the jacket to be converted to a vest. White or near-white LEDs may also be attached to the side portions (14) of the jackets (not shown).

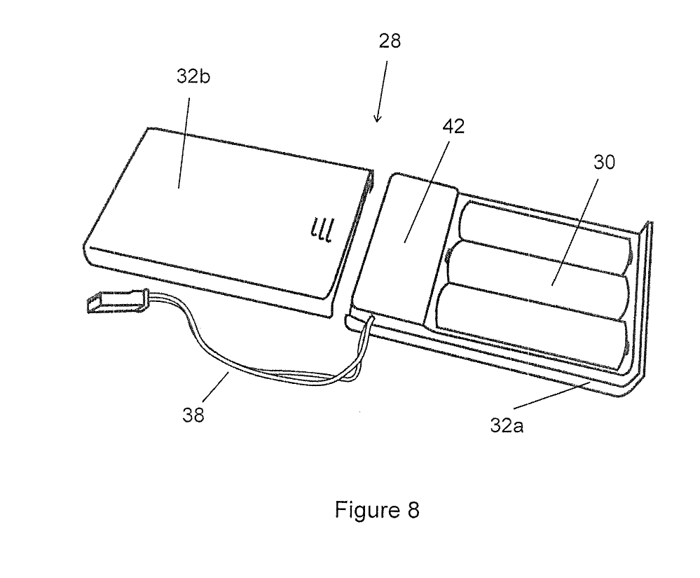

The LEDs (22, 26) are activated by power means (28) comprising at least (see FIG. 8) a battery (30); a plastic waterproof housing (32a and 32b) and connection means. The connection means comprise wires (38, 40) that connect the negative and positive terminals of the battery (30), either directly or indirectly, to individual LEDs (22, 26). Preferably, the LED's are not connected directly to the power source, but via a control circuit in order to control and limit the current delivered to said LEDs. Typically, the battery may comprise three 1.5 Volt cells. The LEDs are normally wired in parallel. The waterproof housing (32) further comprises a rubberized membrane switch (36) on top; each time the switch (36) is depressed conventional control electronics within the housing (32a) cycles the LED arrays through one of three different stages. Upon first depression the LED arrays (22, 26) will intermittently flash in a manner similar to flashing lights used on emergency service vehicles; upon second depression the LEDs will flash on and off at a steady rate; upon a third depression the LEDs will illuminate continuously; one more press turns the LED arrays off. The strips (20, 24) need not necessarily be positioned vertically on the jacket (as shown in FIGS. 1 and 2); for example they may be positioned horizontally or may even be positioned to form a logo; such as a star.

The rear LEDs (22) may be activated independently of the front LEDs (26). In this case the red (22) and white (26) LED's are each separately controlled by the power means (28); as they may require different electrical control characteristics; these circuits typically comprise electronic circuitry (not shown), encapsulated in the single plastic water proof housing (42); each array of LEDs (22, 26) being powered from the same battery (30). Preferably, the power means (28) mode of operation is controlled by a single operation switch (36).

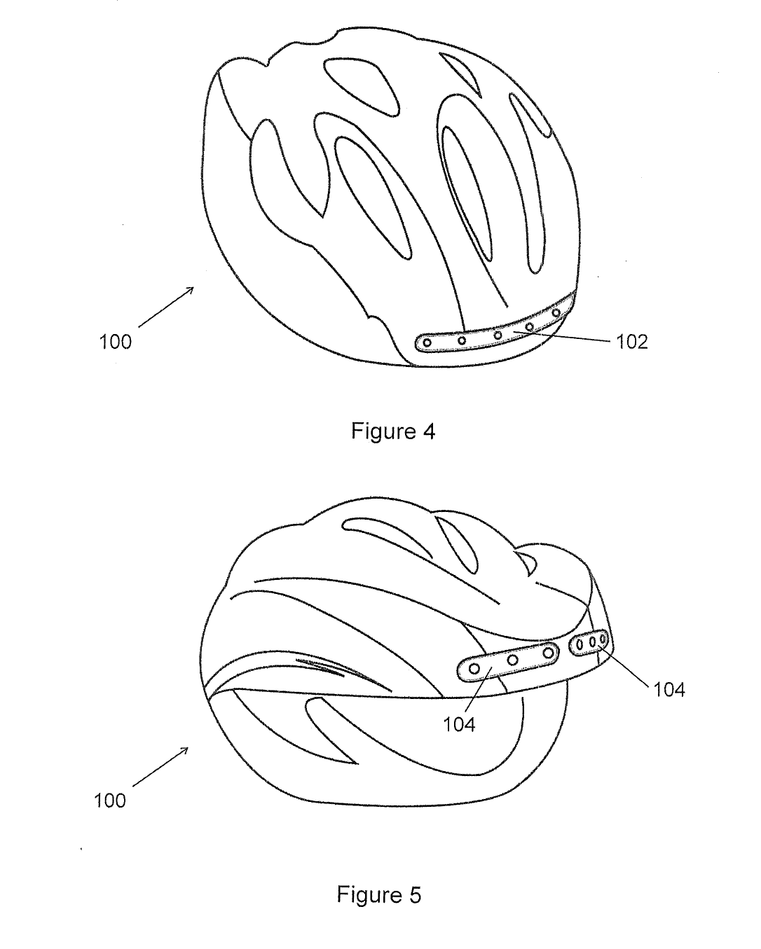

In another embodiment, the invention may be used with a safety helmet; for example a helmet used by a bicyclist. FIGS. 4 and 5 show such a helmet (100) having an array (strip) of white LEDs (102) on the front and two arrays (strips) of red LEDs (104) on the rear of the helmet. The power means and connection means (not shown) can be similar to that described above for the preferred embodiment.

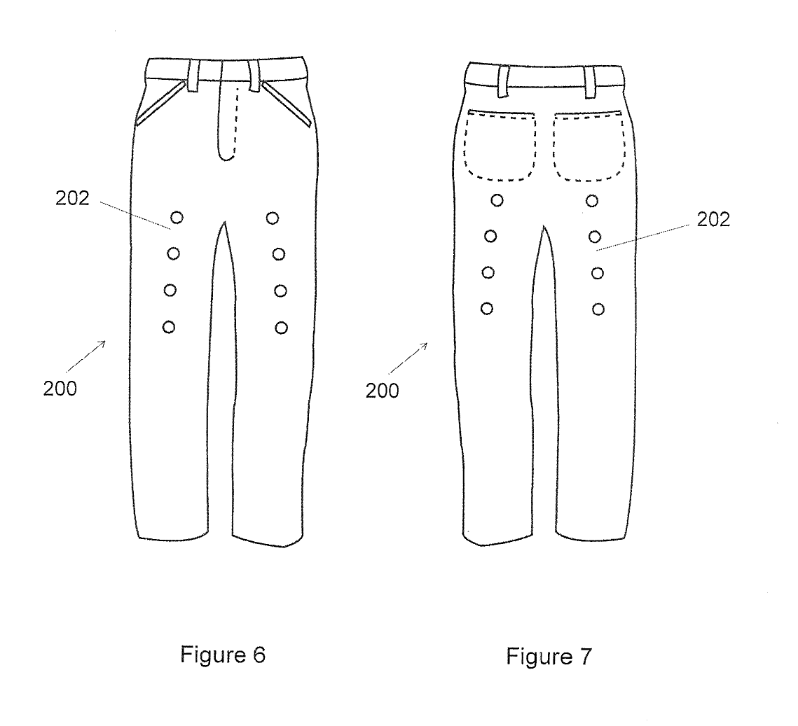

In a further embodiment, the invention may be used with a pair of trousers. FIGS. 6 and 7 show a pair of trousers (200) having arrays (strips) of white LEDs (202) located vertically down each front leg portion and similar strips (204) of red LEDs located down each rear leg portion. Again, the power means and connection means (not shown) can be similar to that described above for the preferred embodiment; the power means being stowed within a pouch provided within the trousers.

The invention can also be used with a back pack; at least one strip of red LEDs being attached or attachable to the rear of the back pack and a strip of white LEDs being attached (for example by Velcro™) to the front of a garment worn by a user.

The control electronics preferably used in all of the above embodiments typically allow the LEDs to operate in four modes, off, constantly illuminated, intermittent and constant period “flash”. The last two modes providing excellent visibility of the wearer in extreme dark and low visibility conditions including poor weather and hazardous conditions. Advantageously, the use of red LEDs on the rear of the garment and white LEDs on the front provide a distinctive method of showing directional movement of the wearer.

I claim:

1. A method protecting a pedestrian or cyclist from accidental collision with a vehicle comprising the following steps:
a) mounting either directly or indirectly a first strip on the rear of a user; said first strip comprising a plurality of light emitting devices that emit red light upon activation by a power means; and
b) mounting either directly or indirectly a second strip on the front of a user; said second strip comprising a plurality of light emitting devices that emit white or near white light upon activation by said power means.

2. The method according to claim 1, wherein said first and second strips form an integral part of a garment worn by a user.

3. The method according to claim 2, wherein the garment comprises a jacket or trousers.

4. The method according to claim 2, wherein the garment comprises a soft or a hard hat.

5. The method according to claim 2, wherein the power means comprise a plurality of cells within a holder, operably connectable to said light emitting devices by a parallel wiring system, said holder being and attached to or stowed within said garment.

6. The method according to claim 1, wherein the light emitting device comprises a light emitting diode.

7. An apparatus for protecting a pedestrian or cyclist from accidental collision with a vehicle comprising a first strip adapted for detachable mounting either directly or indirectly on the rear of a user; said first strip comprising a plurality of light emitting devices that emit red light upon activation by a power means; and a second strip adapted for detachable mounting either directly or indirectly on the front of a user; said second strip comprising a plurality of light emitting devices that emit white, near white light upon activation by said power means.

8. The apparatus according to claim 7, wherein said first and second strips form an integral part of a garment worn by a user.

9. The apparatus according to claim 8, wherein the garment comprises a jacket or trousers.

10. The apparatus according to claim 8, wherein the garment comprises a soft hat or a hard hat.

11. The apparatus according to claim 8, wherein the power means comprise a plurality of cells within a holder, operably connectable to said light emitting devices by a parallel wiring system, said holder being and attached to or stowed within said garment.

12. The apparatus according to claim 7, wherein the light emitting device comprises a light emitting diode.

13. A garment for protecting a person from accidental collision with a vehicle that in use presents an array of red LEDs on the backside of the garment and an array of white or near white LEDs on the front of the garment, said arrays being powered by a battery pack that is attached to or stowed within said garment.

14. The garment according to claim 13, wherein the garment is a jacket, a coat, a pair of trousers, or a hat.
